(19) United States
(12) Patent Application Publication
(10) Pub. No.: US 2013/0244119 A1
(43) Pub. Date: Sep. 19, 2013

(54) GRAPHENE-CONTAINING SEPARATOR FOR LITHIUM ION BATTERIES

(71) Applicant: LI-TEC BATTERY GMBH, Kamenz (DE)

(72) Inventor: Tim Schaefer, Niedersachswerfen (DE)

(73) Assignee: Li-Tec Battery GmbH, Kamenz (DE)

(21) Appl. No.: 13/799,499

(22) Filed: Mar. 13, 2013

Related U.S. Application Data
(60) Provisional application No. 61/611,616, filed on Mar. 16, 2012.

(30) Foreign Application Priority Data
Mar. 16, 2012 (DE) 10 2012 005 348.7

(51) Int. Cl. H01M 2/16; H01M 2/14

(52) U.S. Cl. CPC H01M 2/1633; H01M 2/145
USPC 429/249; 429/247; 427/122

(57) ABSTRACT

A separator for a lithium ion battery, characterized in that same comprises graphene.

The present invention relates to a separator for a lithium ion battery.

Rechargeable lithium ion batteries for use in vehicles with hybrid or wholly electric drive or as stationary storage devices must meet high safety requirements. In conjunction hereto, the separator used in the battery is of great importance. Needing to prevent short circuits in the battery and remain stable under mechanical stress, it also needs to be a good conductor of lithium ions.

The object of the present invention is that of providing a separator for an electrochemical cell, preferably for a rechargeable lithium ion battery, able to increase the safety of an electrochemical cell, preferably a rechargeable lithium ion battery, without (significant) negative impact on the conductivity.

This object is accomplished by providing a graphene-containing separator for an electrochemical cell, preferably for a rechargeable lithium ion battery, as defined in claim 1. Advantageous further developments are defined in the subclaims.

Accordingly, one embodiment of the invention relates to a separator for a lithium ion battery comprising graphene.

Within the context of the present invention, it was found that using graphene in the separator of an electrochemical cell, preferably a lithium ion battery, can increase at least the separator's mechanical stability. Additionally, the outgassing of volatile components from the separator upon the battery being damaged such as e.g. fluorinated compounds or other more volatile components contained in battery electrolytes can be advantageously hindered or even inhibited completely.

The term “separator” in the sense of the invention relates to a material which separates the positive electrode from the negative electrode in an electro-chemical cell, particularly in a rechargeable lithium ion battery. Said material needs to be permeable to lithium ions; i.e. conductive to lithium ions.

The term “graphene” in the sense of the invention denotes a two-dimensional modification of the carbon structure in which each carbon atom is enclosed by three further carbon atoms so as to form a honeycomb pattern.

As used within the meaning of the invention, graphene can—due to the manufacturing process, e.g. by graphite oxide reduction—contain further atoms or groups differing from carbon. Graphene can therefore also contain oxygen, for example in the form of hydroxyl or carboxyl groups, as well as nitrogen, sulfur or alkali metal cations or mixtures of two of more thereof.

In one embodiment, it is also possible for the graphene to comprise further substances present within the graphene as nanoparticles or as nanoparticles at least partially coating the graphene. Applicable nanoparticles are preferably nanoparticles which comprise or are composed of silicon or tin or tin alloys.

The graphene can be a film or in the form of nanotubes as well as nanoparticles. Applicable manufacturing processes are known from the prior art.

### INVENTIVE SEPARATOR EMBODIMENTS

In one embodiment according to the invention, the separator can be a ceramic separator which in turn preferably comprises graphene.

In a further embodiment according to the invention, the separator can comprise or be composed of a polymer which in turn preferably comprises graphene.

Accordingly, a first aspect of the invention relates to a separator which comprises a polymer which in turn preferably comprises graphene.

All polymers normally used in or as separators can be used as the polymer.

As used in the sense of the invention, the term “polymer” includes organic as well as also inorganic polymers.

In one embodiment, the polymer is selected from among the group consisting of: polyester, preferably polyethylene terephthalate or polybutylene terephthalate;

polyolefin, preferably polyethylene, polypropylene or polybutylene; polyacrylonitrile; polycarbonate; polysulfone; polyethersulfone; polyvinylidene fluoride; polystyrene; polyetherimide; polyether and polyether ketone.

Using glass fibers or cellulose fibers in a separator or as a separator is likewise possible.

The polymer can be employed in the form of fibers. The fibers can be woven or unwoven. They can form a woven or unwoven fibrous web. The fibrous web is preferably unwoven.

Instead of the term “unwoven,”the term “non-woven”is also used in the sense of the invention. The relevant technical literature also uses terms such as “non-woven fabrics” or “non-woven material.” The terms “fibrous web” and “non-woven” are used synonymously.

Fibrous webs are known from the prior art and/or can be manufactured according to known methods, for example spinning processes with subsequent solidification. The fibrous web is preferably flexible and is manufactured at a thickness of less than 30 μm.

The polymer fibers are preferably selected from among the group of polymers consisting of polyester, polyolefin, polyamide, polyacrylonitrile, polyimide, polyetherimide, polysulfone, polyamide-imide, polyether, polyphenylene sulfide, aramide or mixtures of two or more of these polymers.

Polyesters are e.g. polyethylene terephthalate and polybutylene terephthalate.

Polyolefins are e.g. polyethylene or polypropylene. Polyolefins containing halogen such as polytetrafluoroethylene, polyvinylidene fluoride and polyvinyl chloride can likewise be employed.

Polyamides are e.g. the PA 6.6 and PA 6.0 types, as known by their trade names of Nylon® and Perlon®.

Aramides are e.g. meta-aramid and para-aramid material, as known by their trade names of Nomex® and Kevlar®.

Polyamidimides are e.g. known by the trade name of Kermel®.

In one embodiment, the invention relates to a separator comprising a polymer which comprises graphene.

In one embodiment, the separator comprises a polymer with graphene being present in the polymer.

The term “in the polymer” as used herein means that the polymer completely encases the graphene.

In one embodiment, the separator comprises a polymer with graphene being present on the polymer.

The term “on the polymer” as used herein means that the polymer does not completely encase the graphene.

In one embodiment, the separator comprises a polymer in the form of a fibrous web of woven or non-woven unwoven fibers, wherein non-woven (e.g. unwoven) fibers are particularly preferred.

In a further embodiment, the separator comprises a polymer in the form of a fibrous web of woven or unwoven fibers with graphene present in the fibers.

The term “in the fibers” as used herein means that the polymer completely encases the graphene.

In a further embodiment, the separator comprises a polymer in the form of a fibrous web of woven or unwoven fibers with graphene present on the fibers.

The term “on the fibers”as used herein means that the polymer at least does not completely encase the graphene.

In a further embodiment, the separator comprises a polymer in the form of a fibrous web of woven or unwoven fibers with graphene being in and on the fibers.

In a further embodiment, the polymer employed can be a film, preferably in the form of a membrane. The film preferably exhibits pores which are permeable to lithium ions.

Hence, in one embodiment, the polymer is in the form of a porous film, wherein the film comprises graphene.

In one embodiment, the separator comprises a polymer in the form of a porous film with graphene being present in the film.

The term “in the film” as used herein means that the polymer completely encases or surrounds the graphene.

In a further embodiment, the separator comprises a polymer in the form of a porous film with graphene being present on the film.

The term “on the film” as used herein means that the polymer at least does not completely encase the graphene.

In a further embodiment, the separator comprises a polymer in the form of a porous film with graphene being in and on the film.

In accordance with a second aspect, the invention relates to a separator comprising an inorganic material.

The term “inorganic material” as used herein includes ion-conducting material, preferably a material conductive to lithium ions.

The ion-conducting inorganic material is preferably conductive to ions; i.e. preferably ion-conductive to lithium ions, in a temperature range of between −40° C. and 200° C.

The inorganic ion-conducting material preferably comprises at least one compound from among the group of oxides, phosphates, sulfates, titanates, silicates and aluminosilicates having at least one of the elements zircon, aluminum and lithium, with zirconium oxide being particularly preferred. The inorganic ion-conducting material preferably comprises particles having a diameter of less than 100 nm.

In one preferred embodiment, the ion-conducting material comprises or consists of zirconium oxide.

In one embodiment, the separator comprises an inorganic material conductive to lithium ions, wherein the inorganic material comprises graphene.

In a further embodiment, the separator comprises an inorganic material which is conductive to lithium ions with graphene being present in the inorganic material.

The term “in the organic material” as used herein means that the inorganic material completely encases or surrounds the graphene.

In a further embodiment, the separator comprises an inorganic material which is conductive to lithium ions with graphene being present on the inorganic material.

The term “on the inorganic material” as used herein means that the inorganic material at least does not completely encase (or surround) the graphene.

In a further embodiment, the separator comprises an inorganic material which is conductive to lithium ions with graphene being in and on the inorganic material.

In accordance with a third aspect, the invention relates to a separator which comprises a polymer comprising graphene as defined in the first aspect, wherein the polymer is coated with an inorganic material conductive to lithium ions.

The inorganic material conductive to lithium ions is thereby preferably a material as defined in the second aspect.

In one embodiment, the separator comprises a polymer with graphene being present in said polymer, wherein the polymer is coated with an inorganic material which is conductive to lithium ions.

In a further embodiment, the separator comprises a polymer with graphene being present on said polymer, wherein the polymer is coated with an inorganic material which is conductive to lithium ions.

In one embodiment, the polymer is in the form of a fibrous web of woven or non-woven fibers with graphene being present in said fibers, wherein the polymer is coated with an inorganic material which is conductive to lithium ions.

In one embodiment, the polymer is in the form of a fibrous web of woven or non-woven fibers with graphene being present on said fibers, wherein the polymer is coated with an inorganic material which is conductive to lithium ions.

In one embodiment, the polymer is in the form of a fibrous web of woven or non-woven fibers with graphene being in and on said fibers, wherein the polymer is coated with an inorganic material which is conductive to lithium ions.

The ion-conducting inorganic material used for the coating is preferably at least one compound from among the group of oxides, phosphates, sulfates, titanates, silicates and aluminosilicates of at least one of the elements of zircon, aluminum or lithium.

The ion-conducting inorganic material is preferably conductive to ions; i.e. ion-conductive to lithium ions, in a temperature range between −40° C. and 200° C.

One embodiment can use a separator consisting of a substrate which is at least partially permeable to material and not or only poorly conductive to electrons. At least one side of said substrate is coated with an inorganic material. An organic material designed as a fibrous web; i.e. of non-woven polymer fibers, is used as the substrate at least partially permeable to material. The organic material is designed in the form of polymer fibers, preferably polymer fibers of polyethylene terephthalate (PET). The fibrous web is coated with an inorganic ion-conducting material which is preferably conductive to ions in a temperature range between −40° C. and 200° C. The ion-conducting inorganic material preferably comprises at least one compound from among the group of oxides, phosphates, sulfates, titanates, silicates and aluminosilicates having at least one of the elements of zircon, aluminum or lithium, zirconium oxide is particularly preferred. The inorganic ion-conducting material preferably comprises particles having a diameter of less than 100 nm.

In one preferred embodiment, the ion-conducting material comprises or consists of zirconium oxide.

The term “coating” as used herein also implies that the ion-conducting inorganic material can not only be provided on just one or both sides of the fibrous web but also within said fibrous web.

An example of such a separator is marketed under the trade name of “Separion”by the Evonik AG company in Germany.

Methods of manufacturing such separators are known in the prior art, for example from EP 1 017 476 B1, WO 2004/021477 and WO 2004/021499.

The fibrous web of this separator comprises graphene in accordance with the invention.

In principle, large pores and holes in separators used in secondary batteries can lead to internal short circuits. The battery can then discharge extremely rapidly in a dangerous reaction. This can give rise to such high electrical currents that in the worst case scenario, a closed battery cell can even explode. For this reason, the separator according to the invention can also contribute significantly to the safety of a high-capacity or high-energy lithium battery.

In general, polymer separators prevent any charge transport as of a specific temperature (the so-called “shut-down temperature,”approximately 120° C.). This ensues by means of the separator's pore structure breaking down at this temperature and all the pores closing. Because no more ions can then be transported, the dangerous reaction which can lead to explosion is impeded. If, however, the cell continues to heat up due to external circumstances, the so-called “break-down temperature”will be exceeded at approximately 150-180° C.

As of this temperature, the separator will melt, whereby it contracts. There is then direct contact between the two electrodes at many points within the battery cell, thus resulting in a large-scale internal short circuit. This leads to the uncontrolled reaction which can end in an explosion of the cell or the resultant pressure needing to be relieved by means of a pressure relief valve (a rupture disk), frequently in the presence of flames or sparks.

In the inventive separator employed in the lithium ion battery comprising a fibrous web of non-woven polymer fibers containing graphene and the inorganic coating, shutdown can only occur when the polymer structure of the substrate material melts due to the high temperature and the inorganic material infiltrates into the pores, thereby closing them. Conversely, the inventive separator does not undergo breakdown since the inorganic particles ensure that the separator cannot melt completely. Thus, maximum precaution is taken to ensure there are no operating conditions in which a large-scale short circuit can occur.

Based on the type of fibrous web utilized, same exhibiting a particularly well-suited combination of thickness and porosity, inventive separators can be manufactured which fulfill the requirements placed on separators for high-capacity batteries, particularly high-capacity lithium batteries. Simultaneously using oxide particles of precisely adapted particle size to manufacture the porous (ceramic) coating achieves a particularly high porosity to the finished inventive separator, wherein the pores are still sufficient small enough to prevent unwanted “lithium whiskers”from growing through the separator.

Due to the inventive separator's high porosity, however, care should be taken to prevent any dead spots from forming in the pores, or just the smallest dead spot possible.

Inventive separators preferably employed for a lithium ion battery also have the advantage of the conducting salt anions partially depositing on the inorganic surfaces of the separator material, this leading to improved dissociation and thus better ionic conductivity in the high-current range.

The inventive separator preferentially employed in the lithium ion battery comprising a flexible fibrous web with a porous inorganic coating on and in said fibrous web, wherein the fibrous web comprises graphene and wherein the material of the fibrous web is selected from (preferably unwoven) polymer fibers, is characterized by the fibrous web having a thickness of less than 30 μm, a porosity of more than 50%, preferably 50-97%, and a pore size distribution in which at least 50% of the pores have a pore radius of 75 to 150 μm.

The inventive separator of fibrous web and ceramic coating preferably has a porosity of 30-80%, preferentially 40-75% and particularly preferentially 45-70%. Porosity thereby refers to the accessible; i.e. open pores. Porosity can thereby be determined by means of the known mercury porosimetry method or can be calculated from the volume and the density of the raw materials employed under the assumption that there are only open pores.

In a further embodiment, the non-woven fibrous web has a porosity of 60-90%, particularly preferentially 70-90%. Porosity is thereby defined as the volume of the fibrous web (100%) minus the volume of the fibers of the fibrous web; i.e. the percentage of the fibrous web's volume not filled with material. The volume of the fibrous web can thereby be calculated from the dimensions of the fibrous web. The volume of the fibers yields from the measured weight of the considered fibrous web and the density of the polymer fibers. The substrate's high porosity also enables a higher porosity to the inventive separator, which is why the inventive separator can accommodate more electrolytes.

It is particularly preferential for the inventive separator to comprise a fibrous web having a thickness of 5-30 μm, preferably a thickness of 10-20 μm. As indicated above, it is also particularly important for the fibrous web to have as homogeneous of a pore size distribution as possible. An even more homogeneous pore size distribution in the fibrous web in conjunction with optimally coordinated oxide particles of specific size results in the inventive separator having an optimized porosity.

The substrate thickness can have a great influence on the properties of the inventive separator since the flexibility as well as also the surface resistance of the inventive electrolyte-saturated separator are contingent upon the thickness of the substrate. A low thickness results in particularly low electrical resistance of the inventive separator in use with an electrolyte. Thinner separators moreover allow increased packing density in a battery stack such that a greater amount of energy can be stored in the same volume.

The polymer fibers of the fibrous web are preferably selected from the above-specified polymers, preferably polyacrylonitrile, polyester such as e.g. polyethylene terephthalate and/or polyolefin such as e.g. polypropylene or polyethylene or mixtures of such polyolefins.

The polymer fibers of the fibrous web preferably have a diameter of from 0.1 to 10 μm; 1 to 4 μm is particularly preferential.

Particularly preferential flexible fibrous webs have a surface weight of less than 20 g/m², preferably 5 to 10 g/m².

The inventive separator in the preferably non-woven fibrous web preferably has a porous, electrically insulating ceramic coating. The porous inorganic coating on and in the fibrous web preferably comprises oxide particles of the Li, Al, Si and/or Zr elements having an average particle size between 0.5 and 7 μm, preferentially 1 to 5 μm, and particularly highly preferentially of 1.5 to 3 μm. It is particularly preferential for the separator to have a porous inorganic coating on and in the fibrous web comprising aluminum oxide particles of an average particle size of between 0.5 and 7 μm, preferentially 1 to 5 μm, and particularly highly preferentially of 1.5 to 3 μm, which are bonded with an oxide of the Zr or Si elements. In order to obtain the highest porosity possible, preferably more than 50 wt % and particularly preferentially more than 80 wt % of all particles fall within the above-cited average particle size range. As described above, the maximum particle size preferably amounts to ⅓ to ⅕ and particularly preferentially less than or equal to 1/10 the thickness of the fibrous web employed.

Inventive separators are also characterized by their ability to exhibit a tensile strength of at least 1 N/cm, preferably at least 3 N/cm, and particularly highly preferentially of 3 to 10 N/cm. The inventive separators can preferably be bent to any radius down to 100 mm, preferably down to 50 mm, and particularly highly preferentially down to 1 mm without damage. This makes the separator also able to be employed in combination with coiled electrodes.

The separator's high tensile strength and bendability also yield the advantage of the separator also being able to undergo the geometrical changes to the electrodes which occur during charging and discharging of a battery without being damaged. This is extremely advantageous in terms of the cell's stability and safety.

It is possible in one embodiment for the separator to be designed such that it exhibits the form of a concave or convex sponge or cushion or the form of wires or felt. This embodiment is well suited to compensating volume changes in the battery. Applicable manufacturing methods are known to the expert.

Hence, the use of graphene in the fibrous web increases the latter's mechanical stability and thus increases the mechanical stability of the inventive separator.

In a further embodiment, the polymer fibrous web comprising graphene used in the separator comprises a further polymer. In one embodiment, the separator is coated on one or both sides with said polymer.

Said polymer can be in the form of a porous membrane; i.e. a film, or in the form of a fibrous web, preferably in the form of a fibrous web of non-woven polymer fibers.

Such polymers are preferably selected from among the group consisting of polyester, polyolefin, polyacrylonitrile, polycarbonate, polysulfone, polyethersulfone, polyvinylidene fluoride, polystyrene and polyetherimide.

The further polymer is preferably a polyolefin. Preferred polyolefins are polyethylene and polypropylene.

The polymer fibrous web comprising graphene is preferably coated with one or more layers of the further polymer, preferably the polyolefin, which is preferably likewise a fibrous web; i.e. non-woven polymer fibers.

A fibrous web of polyethylene terephthalate which is coated with one or more layers of the further polymer, preferably the polyolefin, which is preferably likewise a fibrous web; i.e. non-woven polymer fibers, is preferably used in the inventive separator.

An inventive separator of the above-described Separion type which is coated with one or more layers of the further polymer, preferably the polyolefin, which is preferably likewise a fibrous web; i.e. preferably non-woven polymer fibers, is particularly preferential.

The further polymers, preferably the polyolefin, can be coated on by bonding, lamination, a chemical reaction, welding or by a mechanical connection. Such polymer composites as well as methods for their manufacture are known from EP 1 852 926.

Fibrous webs used in the inventive separator are preferably manufactured from nanofibers of the polymers utilized, whereby fibrous webs are formed which exhibit a high porosity while producing smaller pore diameters. The danger from short circuit reactions can thus be further decreased as well.

The fiber diameters of the polyethylene terephthalate fibrous web are preferably larger than the fiber diameters of the further polymer fibrous web, preferably the polyolefin fibrous web, coating the separator on one or both sides.

The fibrous web manufactured from polyethylene terephthalate then preferably exhibits a greater pore diameter than the fibrous web manufactured from the further polymers.

Using a polyolefin additionally to the polyethylene terephthalate ensures the increased safety of the inventive separator since the pores of the polyolefin contract upon unwanted or too high heating of the cell, reducing or stopping the charge transport through the separator. If the temperature of the electro-chemical cell increases even higher such that the polyolefin begins to melt, the polyethylene terephthalate effectively counteracts the melting down of the separator and thus an uncontrolled destruction of the electrochemical cell.

Hence according to the invention, the separator can be a porous polymer film, a woven or non-woven fibrous web of polymer fibers or a woven or non-woven web of polymer fibers comprising graphene which is coated on one or both sides with an inorganic material able to conduct lithium ions.

In one embodiment, the inventive separator comprises the electrolyte used in the battery. The separator is then preferably saturated with said electrolyte.

In one embodiment, the electrolyte is present in the inventive separator as a solid electrolyte.

Also preferential is an embodiment in which the inventive separator forms a polymer electrolyte together with the lithium salt electrolyte.

In a further embodiment, the polymer is in the form of a porous film, wherein graphene is present in the film, and wherein the polymer is coated with an inorganic material which is conductive to lithium ions.

In a further embodiment, the polymer is in the form of a porous film, wherein graphene is present on the film, and wherein the polymer is coated with an inorganic material which is conductive to lithium ions.

In a further embodiment, the polymer is in the form of a porous film, wherein graphene is present in and on the film, and wherein the polymer is coated with an inorganic material which is conductive to lithium ions.

The polymer in the form of a porous film comprising graphene can be coated with a further polymer as described above. The further polymer can thereby be present in the form of a film or a fibrous web.

In accordance with a fourth aspect, the invention relates to a separator comprising an inorganic material which is conductive to lithium ions according to the second aspect, whereby the inorganic material is coated with a polymer. The polymer is preferably a polymer as defined in the first aspect.

In one embodiment, the separator comprises an inorganic material which is conductive to lithium ions, wherein graphene is present in the inorganic material, and wherein the inorganic material is coated with a polymer.

In one embodiment, the separator comprises an inorganic material which is conductive to lithium ions, wherein graphene is present on the inorganic material, and wherein the inorganic material is coated with a polymer.

In one embodiment, the separator comprises an inorganic material which is conductive to lithium ions, wherein graphene is present in and on the inorganic material, and wherein the inorganic material is coated with a polymer.

In one embodiment, the polymer is a woven or non-woven fibrous web.

In a further embodiment, the polymer is formed as a porous film.

In accordance with a fifth aspect, the invention relates to a separator according to the first aspect, wherein the polymer is coated with an inorganic material which is conductive to lithium ions, whereby the inorganic material comprises graphene.

### Manufacturing An Inventive Separator

In accordance with a sixth aspect, the invention relates to a method of manufacturing an inventive separator comprising at least one of steps (i)-(xi):

(i) Mixing a polymer with graphene;

(ii) Forming fibers from the mixture obtained in (i), wherein the fibers are in the form of a woven or non-woven fibrous web;

(iii) Forming a porous film from the mixture obtained in (i);

(iv) Coating polymer fibers with graphene, wherein the fibers are in the form of a woven or non-woven fibrous web;

(v) Coating a polymer with graphene, wherein the polymer is a porous film;

(vi) Mixing an inorganic material which is conductive to lithium ions with graphene;

(vii) Coating an inorganic material which is conductive to lithium ions with graphene;

(viii) Coating a product obtained in one of stages (ii), (iii), (iv) or (v) with an inorganic material which is conductive to lithium ions;

(ix) Coating a product obtained in one of stages (vi) or (vii) with a fibrous web of woven or non-woven polymer fibers;

(x) Coating a product obtained in one of stages (vi) or (vii) with a polymer which is in the form of a porous film;

(xi) Coating a product obtained in one of stages (ii), (iii), (iv) or (v) with a product obtained in one of stages (vi) or (vii).

The method preferably comprises at least step (i) as well as at least one further step.

The mixing in accordance with stages (i) and (vi), the forming in accordance with stages (ii) and (iii) as well as the coating in accordance with stages (iv) and (v) as well as (vii) to (xi) can be realized by methods as known from the prior art.

### Inventive Lithium Ion Battery

In accordance with a seventh aspect, the invention relates to an electro-chemical cell, preferably a rechargeable lithium ion battery, comprising the separator according to the invention.

### Battery

The terms “lithium ion battery,” “rechargeable lithium ion battery” and “lithium ion secondary battery” are used synonymously. The terms also encompass the terms “lithium battery,” “lithium ion accumulator” and “lithium ion cell.”Thus, the term “lithium ion battery” is used as the collective term for the aforementioned terms common in the prior art. It denotes both rechargeable batteries (secondary batteries) as well as non-rechargeable batteries (primary batteries). In the sense of the present invention, a “battery” particularly also encompasses an individual or sole “electrochemical cell.” Two or more such electrochemical cells are preferably interconnected in one “battery,”either in series (i.e. consecutively) or parallel.

In addition to the inventive separator, the inventive battery also contains at least two electrodes and an electrolyte.

### Electrodes

The inventive electrochemical cell, preferably a lithium ion battery, comprises at least two electrodes; i.e. a first and a second electrode.

The first electrode can thereby be the positive electrode, wherein the second electrode is then the negative electrode, or vice versa.

Both electrodes thereby comprise a material which can conduct lithium ions or intercalate lithium ions or metallic lithium; i.e. a first or a second material.

The term “positive electrode” refers to the electrode able to absorb electrons when the battery is connected to an electrical load, e.g. an electric motor, and constitutes the cathode in the present nomenclature.

The term “negative electrode” refers to the electrode able to discharge electrons when in operation and constitutes the anode in the present nomenclature.

The electrodes preferably comprise inorganic material or inorganic compounds or substances which can be employed for or in or on an electrode or as the electrode. Due to their chemical composition, said compounds or substances can preferably conduct lithium ions and/or absorb (intercalate) lithium ions or metallic lithium and can also discharge to/from the lithium ion battery under the operating conditions. The prior art also refers to such material as the “active material”of the electrode. For use in an electrochemical cell/battery, this material is preferably deposited on a substrate, preferably on a metallic substrate, preferably aluminum or copper.

The metallic substrate is also referred to as a “conductor” or “collector.”

### Positive Electrode

All the materials known from the relevant prior art can be used as the active material for the positive electrode. Thus, the present invention sets no limitations in terms of the positive electrode.

In one embodiment, lithium phosphates can be used as the active material for the positive electrode, preferably of the molecular formula LiXPO₄ where X═Mn, Fe, Co or Ni or combinations thereof.

Further suitable compounds are lithium manganate, preferably LiMn₂O₄, lithium cobaltate, preferably LiCoO₂, lithium nickelate, preferably LiNiO₂, or mixtures of two or more of these oxides or their mixed oxides.

Further compounds can be provided to increase conductivity, preferably carbon-containing compounds or carbon preferably in the form of carbon black or graphite. Carbon in the form of carbon nanotubes can also be introduced. Such additives are preferably applied at a volume of 1-6 wt %, preferably 1-3 wt %, relative to the mass of the positive electrode deposited on the substrate.

The active material can also contain mixtures of two or more of the cited substances.

### Negative Electrode

Suitable materials for the negative electrode are selected from among: lithium metal oxides such as lithium titanium oxide, carbon-containing materials, preferably graphite, synthetic graphite, graphene, carbon black, mesocarbon, doped carbon and fullerene. Niobium pentoxide, tin alloys, titanium dioxide, tin dioxide and silicone are also preferred as electrode material for the negative electrode.

### Bonding Agent

The materials used for the positive or negative electrode such as the active materials, for example, can be bonded by one or more bonding agents bonding these materials to the electrode or conductor respectively. Suitable bonding agents are preferably styrene butadiene rubber (SBR), polyvinylidene fluoride, polyethylene oxide, polyethylene, polypropylene, polytetrafluoroethylene, polyacrylate, ethylene-propylene-diene monomer copolymer (EPDM) and mixtures and copolymers thereof.

### Electrolyte

Components of the electrolyte are at least one organic solvent and a lithium salt. The electrolyte can additionally contain further components.

The term “electrolyte”or “lithium salt electrolyte” preferably refers to a liquid and a conducting salt. The liquid is preferably a solvent for the conducting salt. The electrolyte is then preferably an electrolyte solution.

Suitable solvents are preferably inert. Suitable solvents are preferably solvents such as ethyl carbonate, propylene carbonate, butylene carbonate, dimethyl carbonate, diethyl carbonate, ethyl methyl carbonate, methyl propyl carbonate, butyl methyl carbonate, ethyl propyl carbonate, dipropyl carbonate, cyclopentanones, sulfolanes, dimethyl sulfoxide, 3-methyl-1,3-oxazolidin-2-on, γ-butyrolactone, 1,2-diethoxymethane, tetrahydrofuran, 2-methyltetrahydrofuran, 1,3-dioxolan, methyl acetate, ethyl acetate, nitromethane and 1,3-propanesultone.

In one embodiment, ionic liquids can also be used as solvents. Such “ionic liquids” only contain ions. Preferred cations, which can particularly be alkylated, are imidazolium, pyridinium, pyrrolidinium, guanidinium, uronium, thiuronium, piperidinium, morpholinium, sulfonium, ammonium and phosphonium cations. Examples of applicable anions are halide, tetrafluoroborate, trifluoroacetate, triflate, hexafluorophosphate, phosphinate and tosylate anions.

Noted as examples of ionic liquids are: N-methyl-N-propyl-piperidinium-bis(trifluormethylsulfonyl)imide, N-methyl-N-butyl-pyrrolidinium-bis(trifluormethylsulfonyl)imide, N-butyl-N-trimethyl-ammonium-bis(trifluormethyl-sulfonyl)imide, triethylsulfonium-bis(trifluormethylsulfonyl)imide and N,N-diethyl-N-methyl-N-(2-methoxyethyl)ammonium-bis(trifluormethylsulfonyl)imide.

Two or more of the above-cited liquids are preferably used.

Preferential conducting salts are lithium salts comprising inert anions and which are preferably non-toxic. Preferred suitable lithium salts are lithium hexafluorophosphate, lithium hexafluoroarsenate, lithium-bis(trifluoromethylsulfonylimide), lithium trifluoromethanesulfonate, lithium-tris(trifluoromethylsulfonyl)methide, lithium tetrafluoroborate, lithium perchlorate, lithium tetrachloraluminate, lithium bis(oxalato)borate, lithium difluoro(oxalato)borate and/or lithium chloride and mixtures of one or more of these salts.

One embodiment allows for dispensing with some or all of the organic solvent. In this embodiment, the electrolyte can be a solid mass or a mass of solid-like consistency.

In one embodiment, the electrolyte with the comb polymer is a solid electrolyte or a polymer electrolyte.

The electrolyte can be manufactured by mixing the electrolyte components pursuant known methods.

### Manufacturing the Inventive Battery

The electrode material can preferably be deposited on a metallic substrate in paste form, preferably by calendering or extruding. After the applied paste dries, the active material then forms a coating on the metallic substrate.

In accordance with the invention, a material which comprises or consists of graphene can be deposited on the metallic substrate prior to the active material being deposited on the substrate. Said material is also preferably applied to the substrate in paste form. It is likewise conceivable to deposit material comprising or consisting of graphene in the form of a suspension or solution. The graphene can be present within the suspension in the form of e.g. flakes or tubes. After the volatile components vaporize, material comprising or consisting of graphene remains on the substrate. The coating with the active material can thereafter take place such that a layer of the material comprising or consisting of graphene extends at least partially into the boundary layer formed by the substrate and the active material. As a result, the active material is deposited on the graphene-containing material or the layer formed from graphene, preferably in the manner described above.

In like fashion, the separator used in the battery can be at least partially coated on either one or both sides with a material comprising or consisting of graphene.

After the separator is saturated with electrolyte, the battery can be manufactured by joining the electrodes and the separator together, wherein the latter separates the electrodes from one another; i.e. is positioned between the electrodes.

### Use of A Separator According To the Invention

In accordance with an eighth aspect, the invention relates to using a separator according to the invention in an electrochemical cell, preferably a lithium ion battery.

In one embodiment, the invention relates to using a separator according to the invention in an electrochemical cell, preferably a lithium ion battery, as a gas barrier for volatile components.

The term “volatile component” encompasses all substances found in an electrochemical cell which can convert into the gaseous state. Volatile components are thus preferably the solvents used in or as the electrolyte and are preferably volatilized by thermal effect. The term “volatile component” also further encompasses all volatile substances resulting from decomposition reactions. An example of such a decomposition reaction is water dissolving conducting salts containing fluorine to form volatile hydrogen fluoride.

In one embodiment, the separator according to the invention is used as a gas barrier for hydrogen fluoride or 1,3-propane sultone vapor.

### Use of the Inventive Battery

The inventive electrochemical cell, preferably in the form of a lithium ion battery, can be used to supply energy to portable information devices, tools, electrically powered automobiles, hybrid drive automobiles and to stationary energy storage systems.

The inventive lithium battery can preferably be operated at ambient temperatures of between −40 and +100° C.

The preferred discharge currents of an inventive battery are greater than 100 A, preferably greater than 200 A, preferably greater than 300 A, and further preferentially greater than 400 A.

1. A separator for a lithium ion battery, comprising:
graphene.

2. The separator according to claim 1, wherein the separator comprises a polymer which comprises graphene.

3. The separator according to claim 2, wherein the polymer is in the form of a fibrous web of woven or non-woven fibers.

4. The separator according to claim 2, wherein the polymer is in the form of a porous film.

5. The separator according to claim 1, wherein the separator comprises an inorganic material which is conductive to lithium ions, wherein the inorganic material comprises graphene.

6. The separator according to claim 2, wherein the polymer is coated with an inorganic material which is conductive to lithium ions.

7. The separator according to claim 5, wherein the inorganic material is coated with a polymer.

8. The separator according to claim 7, wherein the polymer is in the form of a fibrous web of woven or non-woven fibers.

9. The separator according to claim 7, wherein the polymer is in the form of a porous film.

10. The separator according to claim 2, wherein the polymer is coated with an inorganic material comprising graphene.

11. A method of manufacturing a separator as defined in claim 1, comprising at least one of steps (i) to (xi):
(i) mixing a polymer with graphene;
(ii) forming fibers from the mixture obtained in (i), wherein the fibers are in the form of a woven or non-woven fibrous web;
(iii) forming a porous film from the mixture obtained in (i);
(iv) coating polymer fibers with graphene, wherein the fibers are in the form of a woven or non-woven fibrous web;
(v) coating a polymer with graphene, wherein the polymer is a porous film;
(vi) mixing an inorganic material which is conductive to lithium ions with graphene;
(vii) coating an inorganic material which is conductive to lithium ions with graphene;
(viii) coating a product obtained in one of stages (ii), (iii), (iv) or (v) with an inorganic material which is conductive to lithium ions;
(ix) coating a product obtained in one of stages (vi) or (vii) with a fibrous web of woven or non-woven polymer fibers;
(x) coating a product obtained in one of stages (vi) or (vii) with a polymer which is in the form of a porous film; and
(xi) coating a product obtained in one of stages (ii), (iii), (iv) or (v) with a product obtained in one of stages (vi) or (vii).

12. A lithium ion battery comprising:
a separator according to claim 1.

13. A method comprising:
using a separator according to claim 1 as a gas barrier for volatile components in an electrochemical cell.

14. The method according to claim 13, wherein the volatile component is hydrogen fluoride or 1,3-propane sultone.

15. The method according to claim 11, comprising:
performing step (i); and
performing at least one further step selected from steps (ii) to (xi).
